(19) United States
(12) Patent Application Publication
(10) Pub. No.: US 2009/0009490 A1
(43) Pub. Date: Jan. 8, 2009

(54) Ultrasonic input device for information display

(76) Inventor: Shih-Chin Yang, Taipei (TW)

Correspondence Address: Shih-Chin Yang, 1199 Wunderlich Drive, San Jose, CA, 95129, US

(21) Appl. No.: 12/217,384

(22) Filed: Jul. 7, 2008

Related U.S. Application Data
(60) Provisional application No. 60/958,239, filed on Jul. 5, 2007.

(51) Int. Cl. G06F 3/033

(52) U.S. Cl. 345/179

(57) ABSTRACT

Present invention provides an ultrasonic input device for information display. The ultrasonic input device includes a stylus 140, an ultrasonic receiving unit 130. The stylus further includes a piezoelectric disk element 210 that vibrates toward a circular opening 225 of a housing 220. A reflective structure 240 supported by a base 250 reflects the vertical plane wave 310 to become 360 degree horizontal plane wave 320. There are pillars 230 for interconnecting a supportive base 250 and the housing 220.

### CROSS-REFERENCE TO RELATED APPLICATION

This non-provisional patent application claims the benefits of prior provisional patent application No. 60/958,239, ultrasonic pen head with reflective cone and writing tip.

### BACKGROUND-FIELD OF INVENTION

The present invention relates generally to the area of information input device, specifically in the field of ultrasonic input device.

### BACKGROUND-DESCRIPTION OF PRIOR ART

Information input device that acquires the position of a stylus is required in modern information systems, the common examples are Wacom's tablet or a transcription system such as Mimio.

Ultrasonic triangulation is one of several choices in acquiring the position of a stylus. In U.S. Pat. No. 4,654,648, Herrington, et al. disclose a wireless cursor control system using ultrasonic triangulation principle by measuring the time difference of received ultrasonic signal at different receiver. Also in U.S. Pat. No. 5,308,936, Biggs, et al. disclose an ultrasonic computer input device using ultrasonic as well as magnetic pulses.

For an ultrasonic input device, it is desirable to have a stylus that could emit signal in 360 degree direction. The omni-directional stylus would allow a user much easier to use it without paying attention to the directivity of the stylus. In U.S. Pat. Nos. 6,411,014 and 6,400,065 Toda, et al. disclose the use of cylindrical transducer in a stylus. Also, in U.S. Pat. Nos. 5,866,856 and 6,292,177, Holtzman, et al. disclose the use of cylindrical transducer in a stylus or an eraser. Cylindrical transducer is typically made of a thin piezoelectric film wrapped around a central support structure, with electrodes applied to inner and outer surface of the film. While the 360 omni-directional signal characteristic is desirable in ultrasonic stylus application, the film is also prone to accidental damage since the film is exposed outside a protective housing and close to a writing surface.

In U.S. Pat. No. 6,300,580, Shenholz, et al. disclose a ultrasonic narrow-band eraser, which has one or two cylindrical ultrasonic transmitters, the ultrasonic signal goes from the transmitters, through a ultrasound conduct tube, and reflects off a cone to create a 360 degree waveform. While it is an advantage to place the cylindrical ultrasonic transmitter inside and above the conduct tube, and preferably apart from the opening of the conduct tube and close to the eraser handle as Shenholz, et al. suggested, but much ultrasonic energy is absorbed or canceled from reflected ultrasonic signal inside the tube, therefore much of the transmitted ultrasonic energy is not utilized, and create a low signal to noise ration for ultrasonic detection system. In a battery powered ultrasonic stylus, wasted ultrasound energy would mean shorter battery life, and become a less economic solution for users.

In U.S. Pat. No. 7,342,350, Toda, et al. also disclose a stylus where a ultrasonic transmitter is placed inside a bore housing together with a writing or drawing element, and tip of the drawing element has a conical reflector to reflect the ultrasonic wave. The opening at the end of the housing tends to be small. Therefore, it has the same disadvantage of wasting ultrasound energy because of the bore and the writing element, together with the small opening at the end of the housing.

In U.S. Pat. No. 6,633,280, Matsumoto also discloses an ultrasonic stylus that has an ultrasonic transmitter inside a housing, the transmitted ultrasonic signal has to go through a small cylindrical hole emits from small openings at the pen tip. Therefore, much ultrasonic energy is wasted along the small cylindrical hole.

While ultrasonic transducers disclosed in U.S. Pat. Nos. 6,087,760, 6,798,403, 5,185,728 and 4,228,379 are stronger than cylindrical film transducers, but they could not send wave in 360 degree by natural or much energy is lost in the housing because of reflected wave canceled with the transmitted wave.

Therefore, it is desirable to have an innovative ultrasonic stylus that could send sound wave in 360 degree, have a stronger structure, also a design that has better utilization of ultrasound energy.

### SUMMARY

It is present invention's object to overcome the shortcomings of prior art.

Specifically, it is one object of present invention to provide a 360 degree waveform. To do so, we would use a reflective structure to reflect a unidirectional waveform to create a 360 degree waveform pattern.

Also, it is another object of present invention to make a stronger stylus. To achieve this, we would use an ultrasonic element inside a plastic housing to protect the ultrasonic element.

Further more, it is additional object of present invention to better utilize transmitted ultrasonic energy. To achieve this object, the ultrasonic element would send its ultrasonic waveform directly onto a reflective structure with shortest distance in between possible.

With present invention's feature, the stylus for information input would be more economic, easier to use and stronger.

### DRAWING FIGURES

The objects and features of the present invention, which are believed to be novel, are set forth with particularity in the appended claims. The present invention, both as to its organization and manner of operation, together with further objects and advantages, may best be understood by reference to the following description, taken in connection with the accompanying drawings.

FIG. 1 shows a perspective view of an ultrasonic information input system

FIG. 2 shows the perspective view of a stylus of present invention

FIG. 3 shows the propagation of ultrasound wave of a stylus of present invention

### REFERENCE NUMERALS IN DRAWINGS

100 Perspective view of a ultrasonic information input system
110 An electronic information display
120 A drawing on display
130 Ultrasonic receiving unit for stylus position tracking
135 Ultrasonic receivers
140 Ultrasonic stylus
200 Perspective view of a stylus of present invention
210 A piezoelectric element
220 A housing for the stylus
225 Circular opening
230 Pillars
240 Reflective structure
245 Axis of reflective structure
250 Supportive base
260 A writing element
270 A push down switch
280 Electronic control circuit
300 Perspective view of propagation of ultrasonic wave of a stylus of present invention
310 Vertical plane wave
320 Horizontal plane wave

### DETAILED DESCRIPTION

This chapter explains present invention in such greater detail so any person skilled in the art would be readily able to make a product based on the outlined principle. One preferred embodiment of present invention is shown. It is obvious that various embodiments could be derived from principle of present invention.

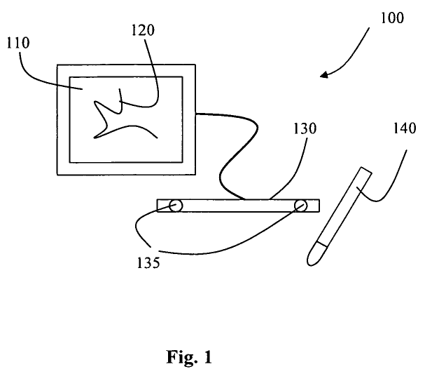

Referring to FIG. 1, a stylus 140 of present invention is illustrated as an input device to an information display device 110, e.g. a computer. The stylus 140 would send ultrasound wave to an ultrasonic receiving unit 130 which has 2 ultrasonic receivers 135. The ultrasonic receiving unit 130 would measure the propagation time of ultrasonic wave between the stylus 140 and any of the 2 ultrasonic receivers 135, and calculate the distance between the stylus 140 and any of the 2 ultrasonic receivers 135 by multiplying with sound speed. With a known distance between 2 ultrasonic receivers 135, the ultrasonic receiving unit 130 would calculate the (X, Y) coordinate of the stylus based on triangulation. Various means could be utilized between stylus 140 and ultrasonic receiving unit 130 for synchronization, which could be a wire, by infrared or by electromagnetic.

Further, once a (X, Y) coordinate is acquired, the ultrasonic receiving unit 130 would transfer the (X, Y) coordinate to an information display device 110. The information display device 110 would then be able to draw a pattern based on a sequence of received coordinates. Besides, the information display device may be able to process the received coordinates for other purposes.

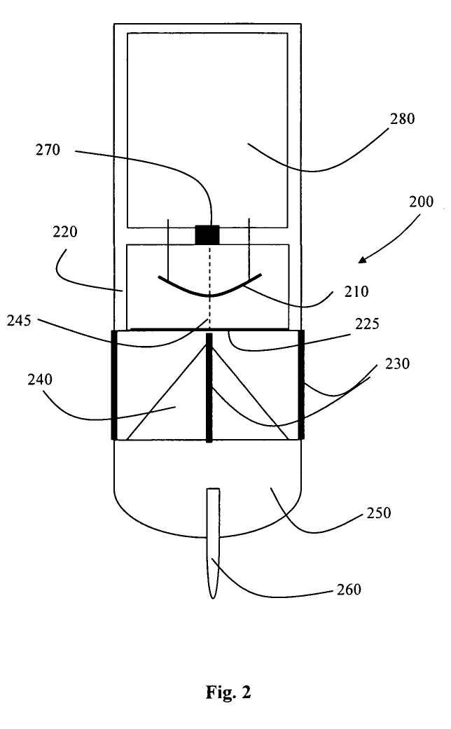

Referring to FIG. 2, a stylus of present invention is shown. There is a stylus housing 220, the housing has a circular opening 225 at one end of the housing. Inside the housing 220, there is an electronic control circuit 280 for providing required ultrasonic driving signal, preferably above 20 KHz range. Also, there is a push down switch 270 for detecting a user's operation. Close to the circular opening 225, there is a piezoelectric disk element 210 which lies in an orientation parallel to the circular opening 225. The circular opening 225 preferably has a larger diameter than half of the diameter of the piezoelectric disk element 210. The piezoelectric disk element 210 is preferably located in less than one wavelength of ultrasonic signal from circular opening 225. Further in FIG. 2, there is a reflective structure 240 supported by a supportive base 250, pillars 230 are arranged around the reflective structure 240 to interconnect the supportive base 250 and stylus housing 220. The reflective structure 240 is preferably a cone structure with its axis 245 align with the center of the piezoelectric disk element 210. The apex of reflective structure 240 is preferably within half a wavelength from circular opening 225 in axis 245 direction to allow most of ultrasonic energy incident on reflective structure 240. Pillars 230 are preferably less than 1 millimeter thick, thus allow most of ultrasonic energy pass through space between pillars. In addition, pillars 230 are preferably arranged in an equal spaced manner, to allow symmetry of ultrasonic wave emitted from stylus for all direction. Also, the diameter of the bottom of reflective structure 240 is preferably larger than half of diameter of half of circular opening 225 to reflect most of ultrasonic energy.

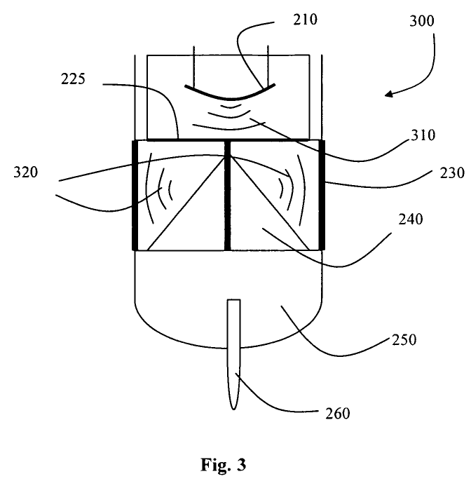

Referring to FIG. 3, piezoelectric disk element 210 vibrates along a direction toward circular opening 225, thus generating a vertical plane wave 310 toward reflective structure 240, which reflects vertical plane wave 310 to become 360 degree horizontal plane wave 320.

As shown in the above embodiment of presentation, since the piezoelectric disk element 210 is close to circular opening 225, and generates vertical plane wave 310 toward the reflective structure 240 directly, ultrasonic energy is much utilized without loss compared to prior arts.

Also, since the piezoelectric disk element 210 is inside a housing 220, it is much protected compared to cylindrical transmitters used in prior art, and thus stronger.

Furthermore, the use of reflective cone would make the unidirectional piezoelectric disk element to generate ultrasonic wave in 360 degree direction.

Therefore, present invention overcome the shortcomings of prior art, and provide an advantageous solution for an ultrasonic input device to an information display.

What is claimed is:

1. An ultrasonic input device for information display consists of an ultrasonic receiving unit having 2 ultrasonic receivers;
a stylus having a housing, a circular opening at one end of said housing, a piezoelectric disk element, a reflective structure, a supportive base for said reflective structure, at least a pillar for interconnecting said supportive base and said housing;
said piezoelectric disk element orients in parallel to said circular opening;
said piezoelectric disk element vibrates toward said circular opening;
said pillars surround said reflective structure.

2. An ultrasonic input device for information display of claim 1, wherein said stylus include a writing element in bottom of said supportive base;

3. An ultrasonic input device for information display of claim 2, wherein said writing element is removable from said supportive base;

4. An ultrasonic input device for information display of claim 1, wherein said stylus includes a wireless mean for synchronizing between said stylus and said ultrasonic receiving unit.

5. An ultrasonic input device for information display of claim 4, wherein said wireless mean is infrared.

6. An ultrasonic input device for information display of claim 4, wherein said wireless mean is electromagnetic.

7. An ultrasonic input device for information display of claim 1, wherein said stylus includes a wire for synchronizing between said stylus and said ultrasonic receiving unit.

8. An ultrasonic input device for information display of claim 1, wherein said pillars are arranged in an equal spaced manner.

9. An ultrasonic input device for information display of claim 1, wherein said reflective structure has a larger diameter in the bottom than diameter of top, axis of said reflective structure aligns with center of said piezoelectric disk element.

10. An ultrasonic input device for information display of claim 1, wherein said piezoelectric disk element is within one wavelength in distance from said circular opening.
